(19) United States
(12) Patent Application Publication
(10) Pub. No.: US 2015/0375769 A1
(43) Pub. Date: Dec. 31, 2015

(54) Adjustable Steering Column Controlled By A Human Machine Interface

(71) Applicant: Robert Bosch Automotive Steering LLC, Florence, KY (US)

(72) Inventors: Pierre Abboud, Northville, MI (US); Ismail Dagli, Farmington Hills, MI (US)

(21) Appl. No.: 14/765,948

(22) PCT Filed: Feb. 7, 2014
(86) PCT No.: PCT/US14/15249

§ 371 Date: Aug. 5, 2015

Related U.S. Application Data
(60) Provisional application No. 61/762,459, filed on Feb. 8, 2013.

(51) Int. Cl. B62D 1/181; B62D 1/184

(52) U.S. Cl. CPC B62D 1/181; B62D 1/184

(57) ABSTRACT

The invention is directed to a device for controlling the position of a steering column of a vehicle. The steering column is adjusted to position the steering wheel in the preferred position for operation of the vehicle by the driver. The device can control the locking mechanism, the vertical position, the depth position or all three features for the steering column. The adjustment for the steering column are made through the use of a human machine interface that allows the driver to use a touch screen or voice commands to control the adjustment features of the steering column.

### CROSS REFERENCE TO RELATED APPLICATIONS

This application claims the benefit of U.S. provisional patent application Ser. No. 61/762,459 filed on Feb. 8, 2013.

### BACKGROUND OF THE INVENTION

An adjustable vehicle steering column is locked to the vehicle chassis by a remote-controlled electrically-operable locking arrangement that is carried solely by a locking arm that is pivotally connected between the steering column and the vehicle chassis. An electrically-operable or manual adjustment mechanism is provided to control the tilt/rake and telescoping adjustment of the steering column. A human machine interface control system is provided to control the locking and in some applications the adjustment mechanisms for the steering column.

### DESCRIPTION OF THE RELATED ART

It is well known in the prior art to provide vehicle steering columns wherein the position of the steering wheel can be adjusted in terms of height and/or in terms of depth. The position of the steering wheel is selected by the driver and is maintained in place by a locking system whose manual control consists of an operating lever that is worked by the driver.

These different types of locking devices, operated by means of a lever, possess several inconveniences. First of all, the lever can be positioned only in the proximity of the locking axis, in other words, in an area where accessibility is reduced along with poor visibility and reachability. Moreover, the locking and unlocking operation necessitates a major effort and is interfered with by the driver's knees. Finally, the operating lever is situated in areas that must be used for other functions so as to provide a good ergonomy for the driver's position. This environment can be the area of computers when the locking axis is placed adjacent or above the column spindle. This type of adjustment mechanism can be operated by the driver while driving the vehicle, although such adjustment is not recommended. This environment can also be the area where the driver's legs are located when the locking axis is placed below the column shaft, which introduces a risk of impact against the knees in case of an accident.

The present invention was developed to provide a device for locking an adjustable automotive vehicle steering column, which will eliminate the above-described inconveniences by providing remote locking control. This remote control must employ a simple and rather small device to allow great adaptation flexibility depending on the type of steering column and the environment of the driver's position.

### BRIEF SUMMARY OF THE INVENTION

Accordingly, a primary object of the present invention is to provide a remote-controlled steering column locking system which includes electrically-operable locking means that are carried by one end of a locking arm that is pivotally connected at its other end with the vehicle chassis, thereby to lock the steering column adjustment means with the vehicle chassis.

According to a more specific object of the invention, the locking device for an adjustable automotive vehicle steering column comprises a steering shaft mounted in a tubular body and capable of rotation around a steering axis. The tubular body is arranged in a support assembly attached upon the vehicle chassis and said steering column can be adjusted in terms of height and/or in terms of depth.

According to another object of the invention, the locking means include an electric actuator having a rotary output shaft, a rotary movement transmission assembly; and a locking system for said steering column. The locking device is characterized in that the electric actuator and the transmission assembly are mounted on a pivotable adjustment support, the adjustment support being connected with a locking rod which passes through said adjustment support and whose axis is collinear with the locking axis and which extends generally normal to the vertical plane passing through the steering axis. The adjustment support is attached to an intermediate element which consists of a pivot element arranged forwardly of the tubular body and is arranged to pivot about an axis mounted in the support assembly, said pivot element being capable of turning around an axis which extends essentially normal to the vertical plane that contains the steering axis.

The locking device according to the present invention thus offers the advantage of easily adapting to each type of steering column and to the position of the locking rod with respect to the steering wheel. The device of the present invention, as a matter of fact, makes it possible to select the best positioning so as to comply with the ergonomy of the driver's position and the safety of the driver's knees in case of an impact. Moreover, the invention makes it possible to prevent any effort directed against the driver for locking and unlocking and any risk of injury during this operation.

The invention makes it possible for the driver to adjust the steering column to position the steering wheel in a desired position. The steering column can be adjusted by use of a human machine interface and preferably an electronic human machine interface. The human machine interface allows the driver to adjust the steering column by touch screen or voice commands that facilitate such adjustment with minimal distraction for the driver. The relocking of the steering column can be done by command and the system can include a default mode whereby the steering column is relocked after the passage of a preselected time interval. It is also possible to incorporate a control strategy that will allow the adjustment system to be operated only during certain parameters. The control strategy could limit the operation of the adjustment system only when the vehicle is not moving or moving below a specified speed. The control strategy could be used to enhance the safe operation of the vehicle.

### BRIEF DESCRIPTION OF THE DRAWINGS

Other objects and advantages of the invention will become apparent from a study of the following specification when viewed in the light of the accompanying drawings, in which:

FIG. 1 is a right side perspective view of the steering column locking means of the present invention.

FIG. 2 is a top right side perspective view of the apparatus of FIG. 1.

FIG. 3 is a detailed left side perspective view of the apparatus of FIG. 1 which certain parts removed for clarity.

FIG. 4 is a sectional view taken along line 4-4 of FIG. 3.

FIGS. 5 and 6 are detailed views of second and third embodiments of the locking means, respectively.

FIG. 7 is a side perspective view of a power adjusted steering column.

FIG. 8 is a top view of the steering column of FIG. 7.

FIG. 9 is a schematic view of the device to control the position of a steering column.

FIG. 10 is a schematic view of the device to control the position of a column.

### DETAILED DESCRIPTION OF THE INVENTION

The invention is directed to a device for controlling the position of a steering column of a vehicle. The steering column is adjusted to position the steering wheel in the preferred position for operation of the vehicle by the driver. The device can control the locking mechanism, the vertical position, the depth position or all three features for the steering column. The adjustment for the steering column are made through the use of a human machine interface, preferably an electronic human machine interface, that allows the driver to use a touch screen or voice commands to control the adjustment features of the steering column. The features of the invention will be more readily understood by referring to the attached drawings in combination with the following description.

The invention can be used with a variety of steering columns. The device of the present invention will be described in connection with a particular steering column that functions particularly well with the present invention. It should be understood that this steering column is being described only to assist in the understanding of the invention. The control device of the present invention can also be utilized with steering columns having different designs for the locking and tilt/rake features without departing from the scope of the invention.

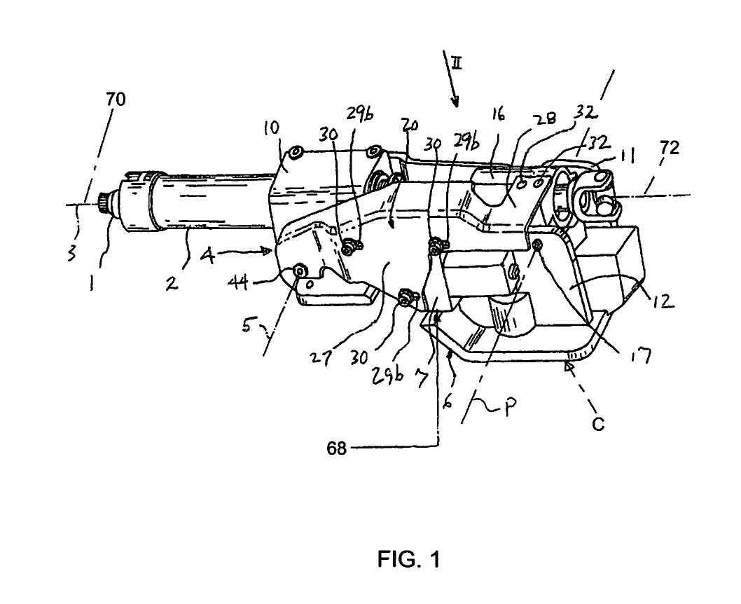

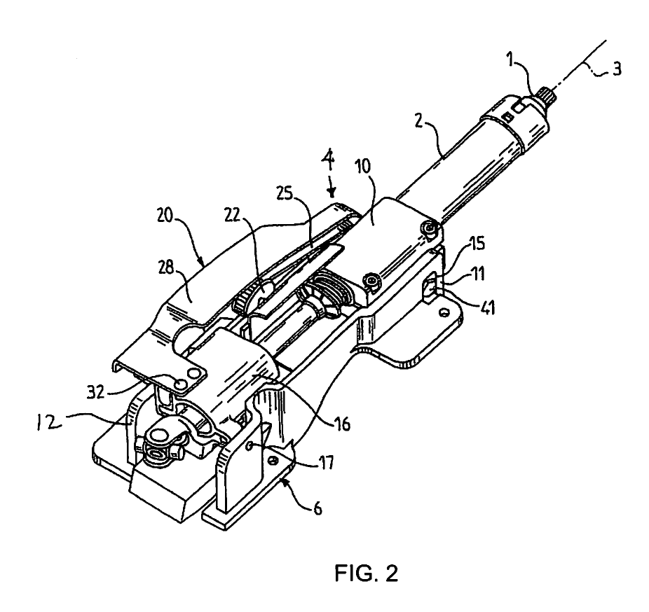

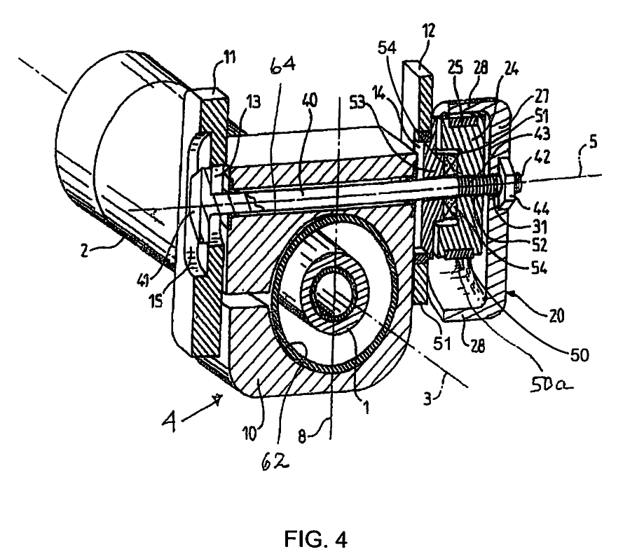

Most adjustable steering columns have a locking feature that must be released to allow the steering column to be adjusted either manually or by a power adjustment. In the present invention, the locking feature is power adjusted and the column shown in FIGS. 1-4 is a manually adjustable steering column. Referring first more particularly to FIGS. 1-4, the vehicle steering column includes a steering shaft 1 that is mounted for rotation within a tubular body 2 and which defines a steering axis 3 contained in a vertical plane 8 (FIG. 4). The tubular body 2 is supported by and extends through a longitudinal through bore 62 contained in a reinforcing guide block 10 that is vertically displaceable between a pair of spaced vertical sidewall portions 11 and 12 of a fixed support member 6 that is secured to the vehicle chassis C.

In accordance with the present invention, locking means are provided for locking the reinforcing guide block 10 to the vehicle chassis following the adjustment of the steering column to the desired position. To this end, a locking rod 40 defining a locking axis 5 extends through transverse bore 64 contained in the reinforcing guide block 10 in a direction normal to the vertical plane 8, as best shown in FIG. 4. At one end, the locking rod 40 extends through a vertical slot 13 contained in the support sidewall 11, which end of the locking rod includes an enlarged non-circular head portion 41 that extends within a counter-bored groove 15 that communicates with the vertical slot 13. At its other end, the locking rod 40 extends through a vertical slot 14 contained in the other support sidewall 12 for connection with locking means 50 having a locking axis 5, as shown in FIG. 4.

The locking means 50 is carried by one end of a locking arm 20 the other end of which is fastened by screws 32 to a tubular pivot member 16 that is pivotally connected with the support sidewalls 11 and 12 for pivotal movement about the pivot shaft 17 having a pivot axis P, as shown in FIG. 1. Thus, in accordance with a characterizing feature of the invention, the distance between the pivot axis P and the locking axis 5 defined by the locking rod 40 is constant regardless of the degree of vertical adjustment of the steering column means relative to the vehicle chassis. The tubular pivot member 16 extends concentrically about the steering shaft 1, as shown in FIG. 1.

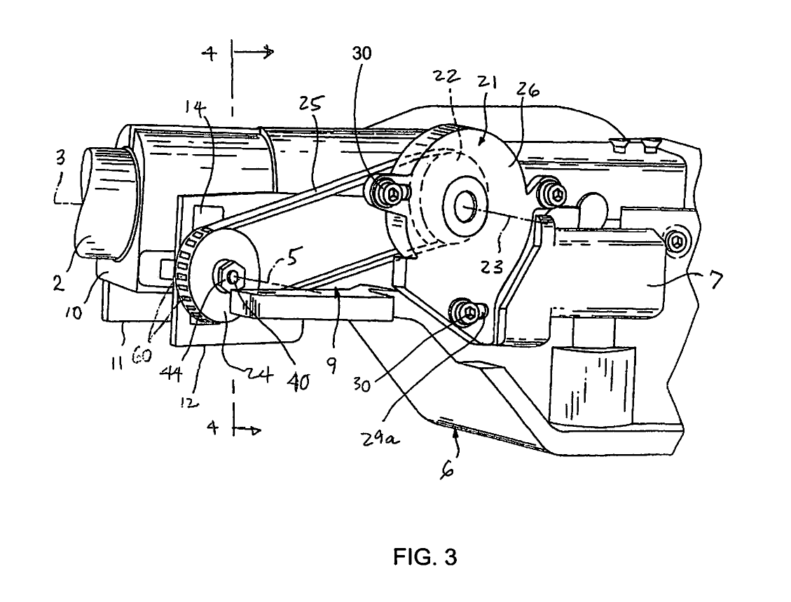

In accordance with another important feature of the invention, the locking means is operable by remote control means including a reversible electric motor 7 that is mounted on a bracket. The electric motor 7 has an output shaft (not shown) that is connected with a drive pulley 22 (FIG. 3) via speed reduction means 21. The drive pulley 22 is connected with driven locking pulley 24 via transmission means 9 including an endless belt 25, as best shown in FIG. 3. The endless belt 25 includes a plurality of longitudinally spaced slots that are engaged by corresponding circumferentially spaced projections 60 carried by both the drive pulley 22 and the driven pulley 24.

Referring again to FIG. 4, the driven pulley 24 is threadably connected with a threaded portion 43 at the end of the locking rod 40. Lock nut 42 is non-rotatably supported by the locking arm 20 and is threadably mounted on one end of threaded portion 42 of the locking rod, and at its other end, the locking rod has a non-circular enlarged head portion 41 that is non-rotatably supported in a counterbored groove 15 that communicates with the vertical slot 13 contained in support side wall portion 11. Mounted adjacent the corresponding vertical slot 14 contained in the other support side wall 12 is a fastening plate 53 that is arranged for engagement with the outer surface of support side wall 12. Ball bearing means 54 are arranged concentrically about the locking rod 40, the ball bearing means being contained in a counterbore 51 formed in the driven locking pulley 24. Thus, when the locking pulley 24 is rotatably driven in one direction by the endless belt 25, the locking pulley is displaced inwardly to cause locking plate 53 to be displaced by the ball bearing race 54 into locking engagement with the adjacent outer wall surface of the support wall 12. Guide block 10 and the vehicle steering column is thus locked in the desired position relative to support member 6 and chassis C. To release the locking plate, the electric motor 7 is operated in the reversed direction by motor control means 68, whereby locking pulley 24 is driven in the opposite direction by drive belt 25 and is displaced axially to the right, thereby to release the locking plate 53 from engagement with the support wall 12. The steering column is then free for vertical and depth adjustment also referred to as tilt/rake and telescoping adjustment of the steering wheel 70 relative to the steering box 72.

To adjust the tension of endless belt 25, the bolts 30 are unfastened thereby to permit adjustment of the speed reduction gearing casing 26 (FIG. 3) relative to the locking arm 20, as permitted by the tension adjusting slots 29a contained in casing 26, and slots 29b contained in locking arm 20.

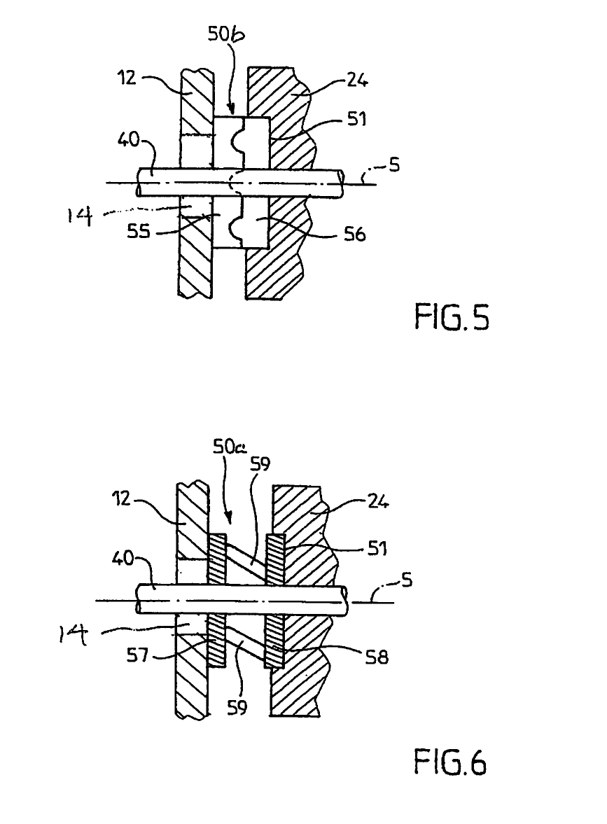

Referring now to the modification illustrated in FIG. 5, the locking means 50b includes a locking cam member 56 that is connected with locking pulley 24 for rotation relative to stationary cam 55 adjacent support wall 12. Thus, when pulley 24 is driven in one direction by drive belt 25, the stationary cam 55 is axially displaced into locked engagement with support wall 12. Operation of the pulley 24 in the opposite direction by reversible motor 7 causes cam 55 to be released from support wall 12.

In the embodiment of FIG. 6, the locking means 50a has a movable locking member 58 is fastened to the driven locking pulley 24 for rotational displacement relative to locking member 57, the locking members being connected by a plurality of connecting links 59. Thus, when pulley 24 is driven in one direction by drive belt 25, the links 59 are pivoted to displace locking plate 57 into engagement with support wall 12. Rotation of pulley 24 in the opposite direction by the reversible motor 7 effects release of the locking plate 57 from the support wall 12.

Although the electric motor 7 has been illustrated as being connected with the driven pulley 24 via endless belt motion transmitting means, it is apparent that other types of transmission means, such as a gear train arrangement, could be used equally as well.

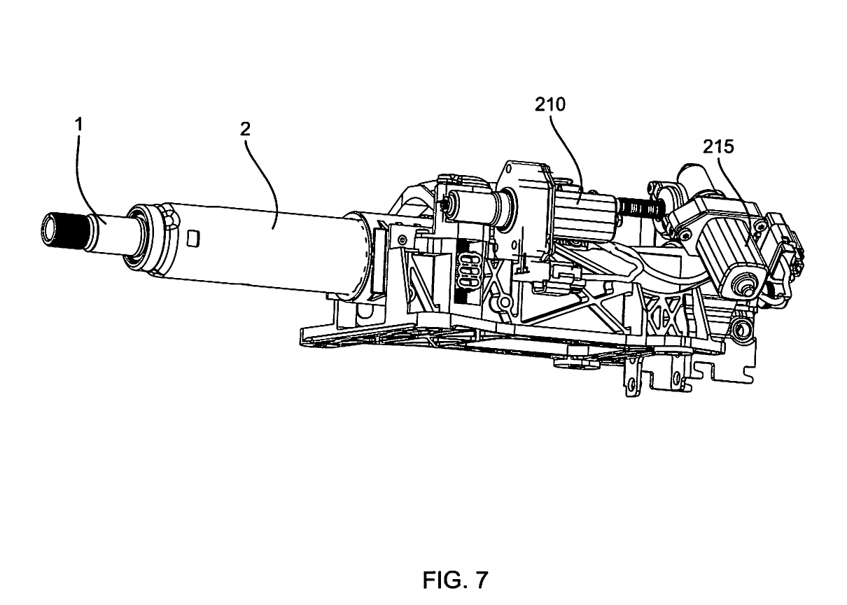

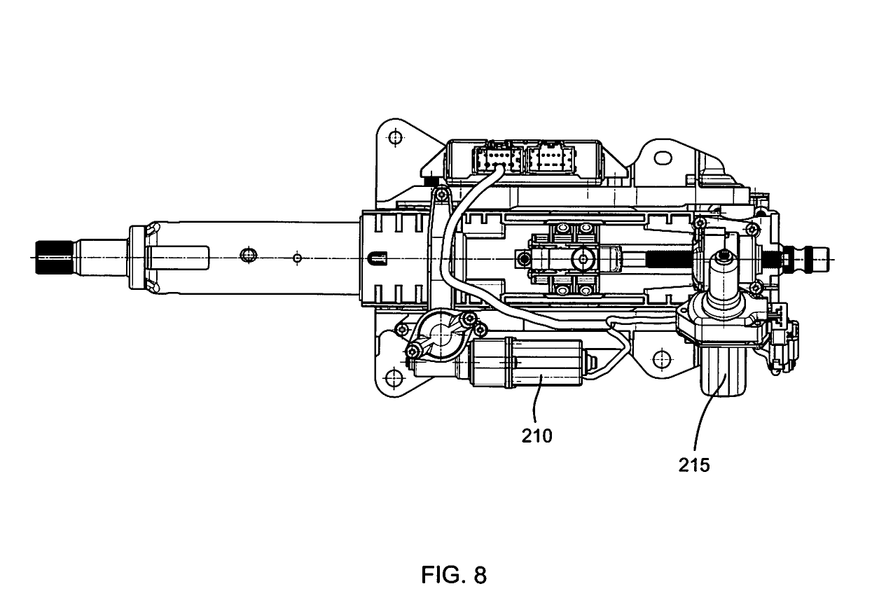

The steering column shown in FIGS. 7 and 8 has a power adjustment for the tilt and telescoping adjustment for the steering column. The other feature of the steering column are essentially the same as the previously described steering column. An electric tilt motor 210 and an electric telescoping motor 215 can be provided for the steering column previously disclosed. The electric tilt motor 210 is operatively connected to the steering column to provide for vertical or tilt/rake adjustment of the steering column relative to a user of the vehicle. The electric telescoping motor 215 is operatively connected to the steering column to adjust the depth or telescoping movement of the steering column relative to the user of the vehicle. The electric tilt motor and the electric telescoping motor can be utilized with the steering column to provide power assist for the vertical and depth adjustments for the steering column relative to the user of the vehicle. The use of motors or powered systems to adjust the tilt and telescoping of a vehicle steering column is known in the art. It should be noted, however, that in many vehicles there is only a manual adjustment of the vertical and depth positions of the steering column relative to the user of the vehicle. In the applications where manual adjustment is being utilized the driver of the vehicle provides the force that is utilized to adjust the vertical and depth positions of the steering wheel attached to the steering column.

In today's vehicles the drivers are becoming more dependent upon electronic interfaces to control the features and accessories of the vehicle. Drivers are used to utilizing touch screen commands on their computers and entertainment systems and the use of voice commands to control various features of electronic devices has become widely used in the last few years. Drivers are requesting that such touch screen and voice activation features be incorporated into the controls for their vehicles.

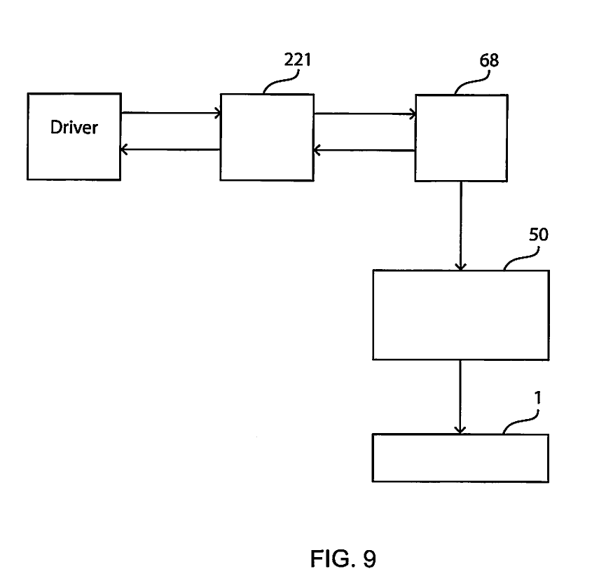

As shown in FIG. 9 there is a schematic for utilizing such electronic interface to control the electrically powered locking and unlocking of a steering column to allow the position of the steering wheel attached to the steering column to be adjusted. A human machine interface (HMI) 221 is operatively connected to the motor control means 68. The HMI is preferably an electronic human machine interface. The sync HMI made by Ford is one example of an HMI that can be used with the present invention. It should be understood, however, that other HMI devices can be used to accomplish the objectives of the invention. The motor control means 68 is operatively connected to the locking means 50 that is connected to the steering shaft 1 of the vehicle. A signal can be sent from the human machine interface 221 to the motor control means 68 to engage the motor control means to lock or unlock the locking means 50 associated with the steering column 1. The human machine interface 221 and the motor control means 68 are usually design to limit the unlocking of the locking means 50 to limited conditions for the vehicle. The human machine interface and the motor control means may, for example, only allow the locking means 50 to be unlocked when the vehicle is not moving, the transmission is in park or the vehicle is not exceeding a certain speed. The limitations on the unlocking of the locking means 50 are to enhance the safe operation of the vehicle. The human machine interface 221 is also frequently designed so that the command to unlock the locking means 50 will only be engaged for a preselected period of time and when this preselected time has expired the locking means will be automatically returned to the locking position. The human machine interface 221 also has the capability of producing a signal that will show the unlocked status of the locking means 50 on a screen or indicator on the dashboard of the vehicle. Other locking means for the steering column can be utilized without departing from the scope of the invention

In operation the driver will provide a command to the human machine interface 221 to unlock the locking means 50. The command can be given to the human machine interface by a voice command, contacting a touch screen or any other suitable command mechanism. Upon receiving the command from the driver the human machine interface will send a signal to the motor control means 68 to activate the motor control means in a manner to release the locking means 50. Once the locking means 50 is released a signal will be sent to the human machine interface by the motor control means 68. The human machine interface can then provide a recognition signal to the driver that the locking means 50 is in the unlocked condition. Once the locking means 50 has been placed in the unlocked position the driver can manually adjust the position of the steering wheel that is positioned on the steering column 1. The adjustments can be to the vertical orientation of the steering wheel, the depth of the steering wheel or both of these positions for the steering wheel can be adjusted by the driver. Once the steering wheel is in the desired position the driver can provide a command to the human machine interface 221 to lock the locking means 50 to secure the steering wheel in the desired position. The command to lock the steering wheel in the desired position will remain in the same manner as the command to unlock the locking means. If the driver does not remember to provide a command through the human machine interface to engage the locking mechanism 50 to lock the steering column in the desired location the human machine interface will by default send a signal to the motor control means 68 to relock the locking means 50 after the passage of a short period of time. The commands by the driver can be to unlock the steering column and if combined with a power column to adjust the steering column or another command that has selected by the driver or the manufacture of the vehicle.

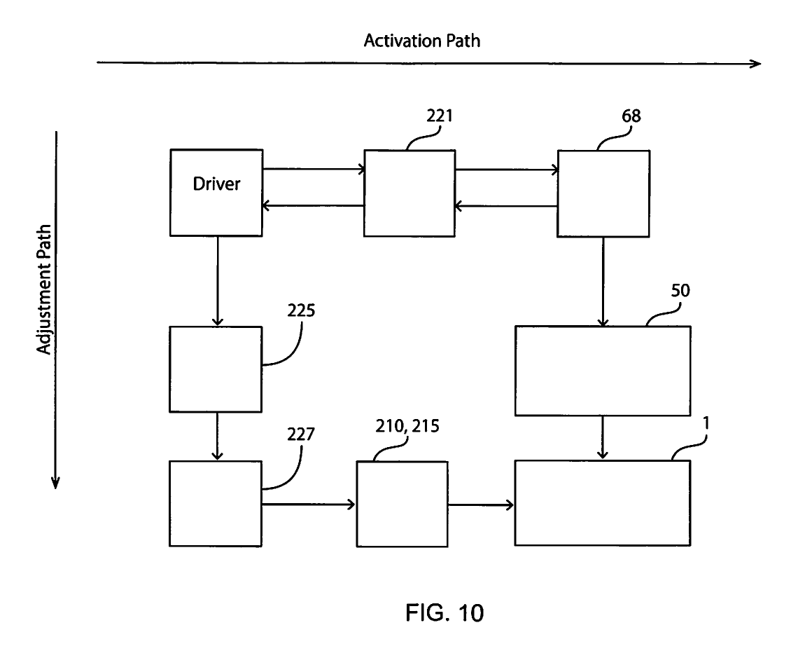

FIG. 10 shows another variation of the invention that can be utilized for a vehicle where the locking and tilt and telescoping adjustments of the steering wheel and steering column are made with a power assist. In this example a human machine interface 221 is utilized to send a signal to the motor control means 68 to activate the locking means 50 to unlock the steering column in the manner previously described to allow the steering column to be adjusted. The same commands can be utilized as previously described. Once the locking means 50 has been unlocked, as acknowledged by a signal on the dashboard, the driver can send a second command to the human machine interface 221 or a command to a second human machine interface 225 to control the position of the steering wheel and steering column 1. The driver can request that the vertical or tilt/rake position of a steering wheel be changed or that the depth or telescoping position for the steering wheel be changed. The human machine interface 221 or the second human machine interface 225 will send a signal to controller 227. Based on the signal receive from the human machine interface 221, 225 the controller will engage electric tilt motor 210 or electric telescoping motor 215 to move the steering wheel and steering column in the manner commanded by the driver. In many applications the driver will adjust one dimension of the steering column and then send a second command to adjust the other dimension for the steering column. In some applications it may require several commands by the driver to position the steering wheel and steering column in the preferred location. The commands by the driver will be made in the same manner as the commands that are used to lock and unlock the locking means 50. Once the driver has the steering wheel in the desired position a command can be made to the human machine interface 221 to lock the locking means 50 in the manner previously described. Locking the locking means 50 will retain the steering wheel in the position selected by the driver. It should be noted that the steering wheel is not easily varied from the selected position by the driver once the commands to the electric tilt and telescoping motors are stopped. Until further commands are made the electric motors will retain the steering wheel and steering column in the last position demanded by the driver. It is, however, preferable that the steering column be again locked to enhance the safe operation of the vehicle. In most applications the human machine interface 221 will send a command through the motor control means to the locking means 50 to engage the locking means after the passage of an interval of time when the locking means has been unlocked.

While in accordance with the provisions of the Patent Statutes the preferred forms and embodiments of the invention have been illustrated and described, it will be apparent to those skilled in the art that various changes may be made without deviating from the inventive concepts set forth above.

What is claimed is:

1. A device for controlling a lock mechanism on a vehicle steering column comprising:
a human machine interface (HMI) accessible by a driver of the vehicle, the HMI capable of receiving commands from the driver and producing a signal in response to the commands;
a controller for responding to the signals from the HMI, the controller sending an order to the lock mechanism for the steering column in response to the command from the driver, the controller being designed to unlock and lock the locking mechanism in response to commands from the driver whereby the steering column can be unlocked and locked based on commands whereby the steering column lock can be controlled to allow the adjustment of the steering column by the driver based on commands from the driver.

2. The device of claim 1 wherein the command from the driver is a verbal command.

3. The device of claim 1 wherein the controller produces a message to the HMI to indicate the locked or unlocked status of the lock mechanism for the steering column.

4. The device of claim 3 wherein the HMI produces a visual indication of the locked or unlocked status of the lock mechanism.

5. The device of claim 1 wherein the controller does not respond to the signal from the HMI under certain vehicle conditions.

6. The device of claim 1 wherein the controller is connected to an electric motor, the electric motor being designed to adjust the steering column for tilt and telescoping movement.

7. The device of claim 6 wherein the HMI is capable of receiving commands from the driver of the vehicle for the adjustment of the tilt and telescoping of the steering column and producing a signal in response to these commands.

8. The device of claim 7 wherein the controller responds to the signals from the HMI and sends an order to the electric motor in response to the HMI signal whereby the tilt and telescoping of the steering column is adjusted as commanded by the driver.

9. The device of claim 8 wherein the electric motor can only be activated when the lock mechanism for the steering column is in the unlocked condition.
